(19) United States
(12) Patent Application Publication
(10) Pub. No.: US 2003/0104850 A1
(43) Pub. Date: Jun. 5, 2003

(54) PDA with a protective cover for its display panel

(76) Inventors: Cheng-Shing Lai, Taipei (TW); Yun Gu, Nanjing (CN); Jun-Yi Zhang, Nanjing (CN)

Correspondence Address: BIRCH STEWART KOLASCH & BIRCH, PO BOX 747, FALLS CHURCH, VA, 22040-0747, US

(21) Appl. No.: 10/000,294

(22) Filed: Dec. 4, 2001

(51) Int. Cl. H04B 1/38

(52) U.S. Cl. 455/575; 455/90

(57) ABSTRACT

The invention relates to a PDA with a protective cover for its display panel. The technology of the invention relates mainly to a sliding protective cover for the body of a PDA (Personal Digital Assistant) with cellular phone functions. The protective cover may slide onto the display panel, providing protection for the display panel. In addition, on the protective cover there is a window opening, so that when the PDA is not in use, the display panel is covered with the protective cover. The display panel shows a small window, which is visible to a user, for displaying messages related to the cellular phone functions.

### FIELD OF THE INVENTION

The invention is a PDA with a protective cover for its display panel. It can be used with a PDA (Personal Digital Assistant) that is equipped with cellular phone functions, so the display panel will be protected by the protective cover.

### BACKGROUND OF THE INVENTION

A PDA is a tiny palm sized computer. It is capable of performing word processing, statistics and calculation, managing databases and spreadsheet creation. Although it works slower than a notebook computer, it not only embodies the general functions commonly used by individuals, but it is also capable of wireless or cable transmission in most cases, and can exchange data with an ordinary personal computer.

In general, given the demand for convenience and portability, a product of this kind is usually made only as big as one's palm. However, in order to display function messages, a PDA still contains a display panel (LCD) that is almost as big as the whole body of the PDA, so the user may easily read and use the information displayed.

Owing to the current trends in PDA development, many models have already integrated cellular phone functions with their PDA functions (PDA +PHONE), so as to enable a PDA to work like a cellular phone.

Some ordinary PDA models have a display panel that is exposed, and not properly protected, so is likely to be damaged from the impact of external objects. Because of this, and as shown in FIG. 1, in order to protect the display panel, certain PDA models provide a cover that swings on hinges, which a user can close to cover the display panel when not using the PDA, and prevent the display panel from being damaged. These kinds of PDAs that have a cover that swings on hinges must have the cover manually opened in order to allow a user to read the messages displayed on the display panel.

Amongst the electronic products that integrate PDA functions with cellular phone functions, some PDA models do not have a cover that swings on hinges, and thus their display panels are unprotected and can be easily damaged. Other models with a cover that swings on hinges are inconvenient to use.

In addition, nearly all PDAs equipped with cellular phone functions have a touch panel, so users who are accustomed to operating a cellular phone by pressing keys are forced to accept this kind of PDA without a choice.

### SUMMARY OF THE INVENTION

In consideration of this, the primary object of the invention is to provide a PDA equipped with cellular phone functions and a protective cover that covers and protects the display panel when functions are not being executed. Moreover, a user can use the cellular phone function in a normal manner without moving the protective cover.

According to the aforesaid object, the invention primarily discloses a sliding protective cover that can slide on the body of a PDA, so when the PDA is not being used, a protective effect may be provided to the PDA through sliding the protective cover over the display panel.

The protective cover has a window opening on it, so even when the protective cover is slid over the display panel, a small area of the display panel can still be viewed through this window opening on the protective cover, and information related to the functions of the cellular phone can still be displayed and viewed. In addition, the protective cover is equipped with function keys for executing operations corresponding to the screen seen through the window opening.

The forgoing objects, features and advantages of the invention will be apparent from the following more particular description of preferred embodiments of the invention, as illustrated on the accompanying drawings.

### BRIEF DESCRIPTION OF THE DRAWINGS

FIG. 1 shows the commonly known structure of a PDA equipped with cellular phone functions.

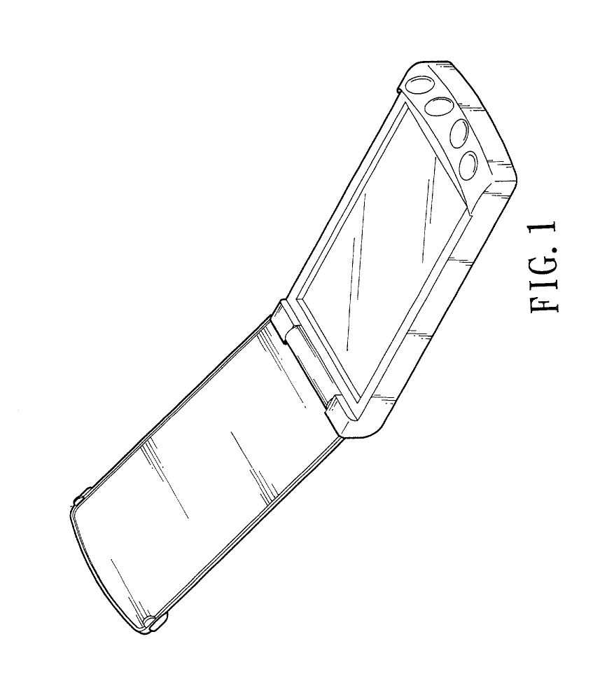

FIG. 2 is a three dimensional diagram of the invention, showing a protective cover in the first position.

FIG. 3 is a three dimensional diagram of the invention, showing a protective cover in the second position.

FIG. 4 is a three dimensional diagram that shows how the invention is assembled.

FIG. 5 shows the structure of the cover on the body of the invention.

FIG. 6 shows another preferred embodiment for the protective cover of the invention.

### DETAILED DESCRIPTION OF THE PREFERRED EMBODIMENTS

The invention relates to a type of PDA with a protective cover, and is especially designed for application on a PDA equipped with cellular phone functions.

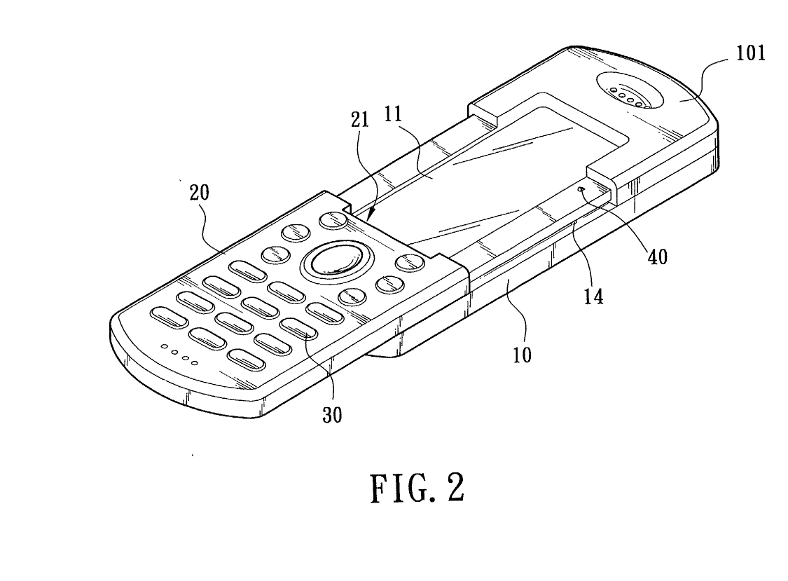

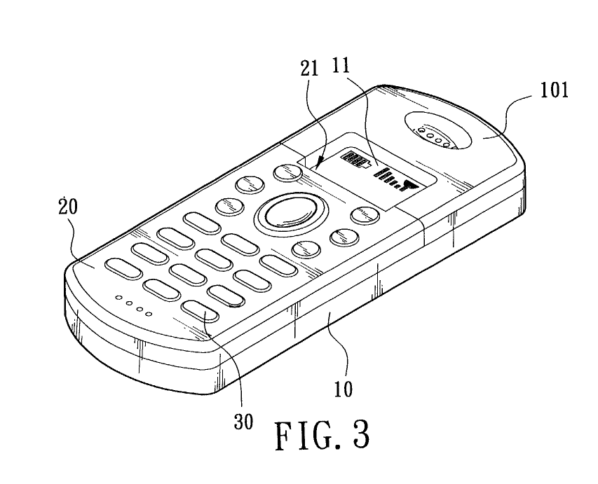

As shown in FIG. 2, the technology disclosed by the invention is primarily a PDA body 10 equipped with a protective cover 20, which has a window opening 21. The protective cover 20 is connected to the PDA body 10, but the protective cover 20 can slide on the PDA body 10 in such a way so that the protective cover 20 can reach the first position, completely exposing the display panel 11 on the PDA body 10, or reach the second position (as shown in FIG. 3), coving the display panel 11 and allowing the display panel 11 to expose only part of its area corresponding to the window opening 21.

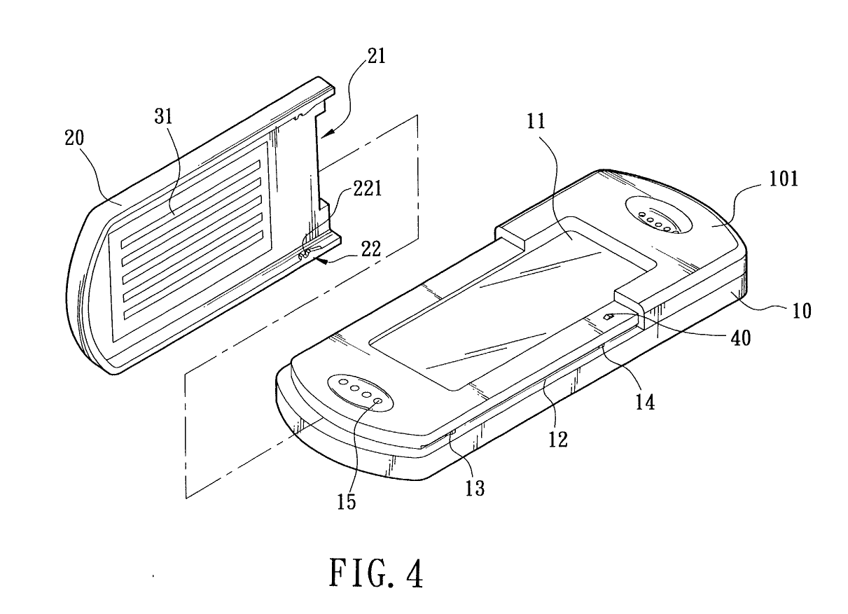

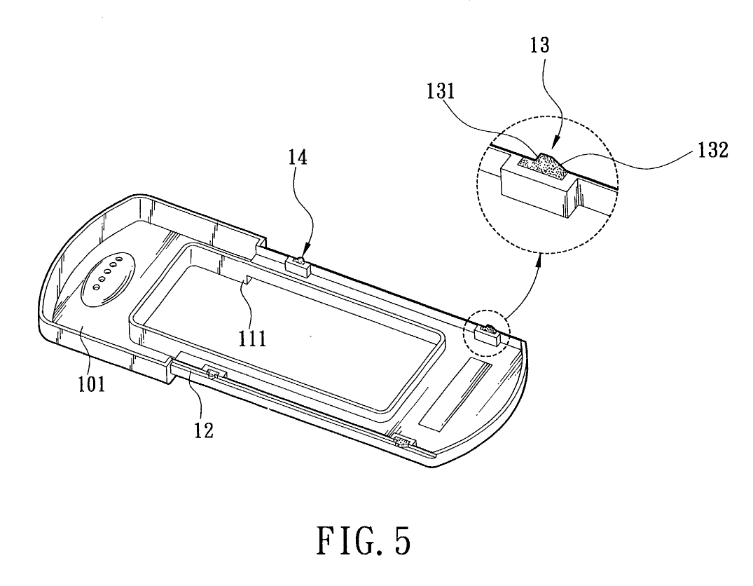

As shown in FIG. 4 and FIG. 5, the aforesaid PDA body 10 and protective cover 20 match, as they have a sliding groove 12 and a locking hook 22, respectively, which lock with each other. The PDA body 10 and the protective cover 20 can move relative to each other when the sliding groove 12 and the locking hook 22 slide on each other. In addition, a block 13 is installed on the PDA body that stops the locking hook 22 from breaking away from the sliding groove 12, ensuring that the protective cover 20 will not slide off the PDA body 10 while the protective cover 20 is in the first position. The aforesaid block 13 can be made from a flexible material (such as rubber), and it can have a stop surface 131 that does not allow the locking hook 22 to break away from the sliding groove 12. It also has a slanted guiding surface 132 that allows the locking hook 22 to go past the block 13 from the external rim of the sliding groove 12 when the locking hook 22 is forced, so that the protective cover 20 that is equipped with the locking hook 22 is restricted by the block 13 and does not break away after entering the sliding groove 12.

In addition, there is a locking groove 221 on the locking hook 22. The counterpart of the locking groove 221 is a locking block 14 found on the PDA body 10. When the protective cover 20 is in the second position, the locking block 14 and the locking groove 221 lock with each other, so that once the protective cover 20 is in that position, it will not slide freely relative to the PDA body 10. The design aims to ensure that when the PDA body 10 is not in use the display panel 11 is covered with, and protected by, the protective cover 20. Since the locking block 14 is also made from a flexible material (such as rubber), when the protective cover 20 is pushed, the locking relationship between the locking groove 221 and the locking block 14 is dissolved, exposing the display panel 11 and allowing a user to read the messages displayed on the display panel 11.

When the protect cover 20 is connected to the PDA body 10 it can slide between the first position and the second position, either exposing or covering the display panel 11. When a user executes the functions of the PDA body 10, the user may move the protective cover 20 to the first position so as to expose the display panel 11 completely. When the user stops using the PDA body 10, the user may move the protective cover 20 to the second position in order to protect the display panel 11. Since there is a window opening 21 on the protective cover 20, a user can see a tiny, uncovered display window when the protective cover 20 is in the second position. The display window displays messages relevant to the execution of the functions of the PDA (such as message receipt, date and time, system name, conversation time, etc) or displays the current status of the PDA body 10 (such as power level, message receipt, etc).

As shown in FIG. 5, there is a lid 101 connected to the PDA body 10 and on the lid 101 is a hole into which the display panel 11 fits. On the external rim of the display panel 11 is a raised encompassing frame 111 which, coupled with the window opening 21, forms the aforesaid display window when the protective cover 20 is in the second position.

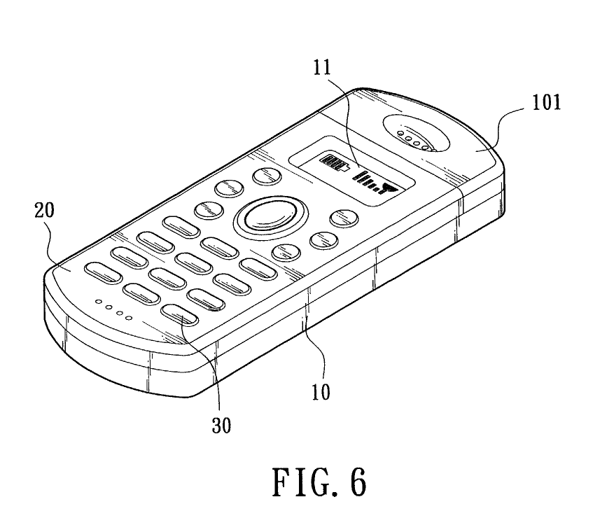

The window opening 21 may appear as illustrated in FIG. 6. That is, it is an opening with a closed rim, requiring no aforesaid lid 101. In other words, the window opening 21 is a closed opening, as opposed to the aforesaid open opening.

The invention aims to minimize the inconvenience caused by the use of cellular phone functions of a PDA. Again, as shown in FIG. 2, functional keys 30 can be directly installed on the surface of the protective cover 20. On the joint surface between the PDA body 10 and the protective cover 20 is an electric plate 15 that is connected to the internal circuit of the PDA body 10, as well as a slide style conductor 31 that is used to connect the aforesaid functional keys 30, respectively, so that the functional keys 30 can be used to perform operations and execution through the connection and conduction between the slide style conductor 31 and the electric plate 15. Furthermore, since the slide style conductor 31 is a long track shaped conductor, it keeps the protective cover 20 in contact with the electric plate 15, so whenever the protective cover 20 is installed on the PDA body 10 and slides to any position relative to the PDA body 10 there is always electrical conduction.

The invention is geared toward PDA equipped with cellular phone functions. When the protective cover 20 moves to the second position relative to the PDA body 10, the display panel 11 may still show a tiny, uncovered display window for displaying messages relevant to the execution of cellular phone functions, while functional operations are carried out by means of the functional keys 30 found on the protective cover 20. In order to allow the full screen displayed pictures to switch to the messages relevant to the execution of cellular phone functions, and be displayed only in the area seen through the window opening 21, a picture switching switch 40 is installed on the PDA body 10. The picture switching switch 40 is located at a place where it can be pressed when the protective cover 20 reaches the second position, so that when the picture switching switch 40 is pressed, a picture displayed on the display panel 11 switches to a picture relevant to cellular phone functions. But, as long as the protective cover 20 moves toward the first position and the picture switching switch 40 is released (not pressed), the display panel 11 shows a picture relevant to the functions of the PDA.

To sum up, the invention is primarily related to the design of a sliding protective cover 20 that is connected to and can slide on a PDA body 10. When a user is not using the PDA body 10, the user can cover the display panel 11 with the protective cover 20 in order to protect the display panel 11 from damage. In addition, the user can use cellular phone functions without moving the protective cover 20. While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A PDA with a protective cover for a display panel comprising:
a PDA body with at least one display panel; and
a protective cover, with a window opening, connected to the PDA body for sliding relative to the PDA body to a first position for completely exposing the display panel and to a second position for covering the display panel with exposing part of the display panel corresponding to the window opening.

2. The PDA as claimed in claim 1, wherein the PDA body and the protective cover respectively have a sliding groove and a locking hook and change relative position by the sliding groove and the locking hook sliding on each other.

3. The PDA as claimed in claim 2, wherein the PDA body has a blocker for preventing the locking hook from breaking away from the sliding groove in the first position.

4. The PDA as claimed in claim 3, wherein the blocker is flexible and has a blocker surface that does not allow the locking hook to break away from the sliding groove and a slanted guiding surface that allows the locking hook to go past the blocker from the external rim of the sliding groove by a compulsive force.

5. The PDA as claimed in claim 1, wherein the PDA body and the protective cover respectively have a locking blocker and a locking groove and the locking blocker and the locking groove lock each other for restricting the protective cover from sliding freely relative to the PDA body in the second position.

6. The PDA as claimed in claim 5, wherein the locking blocker is flexible and dissolving the locking groove and the locking blocker by a compulsive force.

7. The PDA as claimed in claim 1, wherein the PDA body has a hole for fitting the display panel and the display panel has a raising rim coupled with the window opening for forming a tiny display window in the second position.

8. The PDA as claimed in claim 1, wherein the surface of the protective cover has a plurality of function keys.

9. The PDA as claimed in claim 8, wherein the PDA body and the protective cover respectively have an electric induction plate connected to the internal circuit of the PDA body and a sliding conductor used to connect the functional keys so that the function keys is used to perform operations and execution through the connection and conduction between the electric induction plate and the function keys whenever the protective cover is installed on the PDA body and slides relative to the PDA body.

10. The PDA as claimed in claim 1, wherein the PDA body has a picture switching switch and the picture switching switch is pressed in the second position to make the display panel display only pictures relevant to cellular phone functions in an area seen through the window opening and is released in the first position to let the display panel show a picture relevant to the functions of PDA.

11. A sliding cover with attached functional keys, connected to an electronic device equipped with a display panel for covering and protecting the display panel, said sliding cover comprises:
a protective cover with a window opening for exposing only part of the display panel corresponding to the window opening; and
at least one functional key mounted to the protective cover for executing operations corresponding to the pictures displayed through the window opening.

12. The sliding cover as claimed in claim 11, wherein the protective cover has a locking hook for locking onto the electronic device.

13. The sliding cover as claimed in claim 1 1, wherein the window opening is a closed opening.

14. The sliding cover as claimed in claim 11, wherein the window opening is an open opening.
